(19) United States
(12) Patent Application Publication
(10) Pub. No.: US 2018/0141145 A1
(43) Pub. Date: May 24, 2018

(54) WATER TORCH TIP FOR PROVIDING SEPARATE STREAMS OF HYDROGEN AND OXYGEN AT ITS EXIT

(71) Applicants: H-O-D Technologies, LLC, Atlanta, GA (US); Global Ecological Solutions, LLC, Burlingame, CA (US)

(72) Inventors: Leslie Dean Gurvey, Atlanta, GA (US); Leon Kazarian, Burlingame, CA (US)

(73) Assignees: H-O-D Technologies, LLC, Atlanta, GA (US); Global Ecological Solutions, LLC, Burlingame, CA (US)

(21) Appl. No.: 15/359,915

(22) Filed: Nov. 23, 2016

(51) Int. Cl. B23K 5/22; C25B 1/10; C25B 9/10; C25B 11/02

(52) U.S. Cl. CPC B23K 5/22; C25B 11/02; C25B 9/10; C25B 1/10

(57) ABSTRACT

A water torch with tip for providing separate streams of hydrogen and oxygen at its exit includes the tip. The tip has a tip inlet end and a tip outlet end. The tip includes an inner housing and an outer housing. The inner housing has an inner housing inlet port at the tip inlet end in communication with an inner housing outlet opening at the tip outlet end via an inner tip passage. The outer housing surrounds the inner housing. The outer housing includes an outer housing inlet port at the tip inlet end in communication with an outer housing outlet opening at the tip outlet end via an outer tip passage created between the inner housing and the outer housing. The outer housing outlet opening and the inner housing outlet opening are at approximately the tip outlet end, where the outer housing outlet opening surrounding the inner housing outlet opening.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE DISCLOSURE

### Technical Field of the Disclosure

The instant disclosure generally relates to torches for welding, cutting, heating, the like, etc. More particularly, the instant disclosure relates to a tip for a water torch for providing separate streams of hydrogen gas and oxygen gas at its exit, or a water torch with such a tip for providing separate streams of hydrogen gas and oxygen gas at its exit for welding, cutting, heating, the like, etc.

### Description of the Related Art

A water torch is a torch that utilizes distilled water for fuel which generates hydrogen gases and oxygen gases by electrolysis of water. Water torches may be used for the torches to process refractory materials, welding, cutting, heating, the like, etc.

Prior to the instant disclosure, typical water torches mix the hydrogen gases and oxygen gases to create oxyhydrogen prior to burning. Oxyhydrogen is a mixture of hydrogen and oxygen gases, like a mixture of H₂ and O or O₂. Oxyhydrogen created from electrolysis is a ratio of 2:1 hydrogen:oxygen. Theoretically, this 2:1 ratio may be optimal. However, in practice a ratio of 4:1 or 5:1 may be needed to avoid an oxidizing flame when burning oxyhydrogen. Brown's gas and HHO are fringe science terms for a 2:1 mixture of oxyhydrogen obtained under certain special conditions, which may provide special properties. This 2:1 mixture of oxyhydrogen is readily created by the electrolysis of water.

When ignited, the oxyhydrogen gas mixture converts to water vapor and releases energy, which sustains the reaction: 241.8 kJ of energy (LHV) for every mole of H2 burned. The amount of heat energy released is independent of the mode of combustion, but the temperature of the flame varies. The maximum temperature of about 2,800° C. (5,100° F.) is achieved with an exact stoichiometric mixture of oxyhydrogen. When either of the gases are mixed in excess of this ratio, or when mixed with an inert gas like nitrogen, the heat must spread throughout a greater quantity of matter and the temperature will be lower.

For water torches, a pure stoichiometric mixture may be obtained by water electrolysis, which uses an electric current to dissociate the water molecules:

electrolysis: 2H2O→2H2+O2

combustion: 2H2+O2→2H2O

However, the energy required to generate the oxyhydrogen always exceeds the energy released by combusting it, even at maximum efficiency, as the input energy of a closed system will always equal the output energy per the law of thermodynamics states.

Many forms of oxyhydrogen lamps are known, such as the limelight, which uses an oxyhydrogen flame to heat a piece of lime to white hot incandescence. Because of the explosiveness of the oxyhydrogen, limelights have been replaced by electric lighting.

A water torch, also previously known as an oxyhydrogen torch, is an oxy-gas torch, which burns hydrogen (the fuel) with oxygen (the oxidizer) to provide higher burn temperatures than can be provided by just burning hydrogen alone. Water torches can be used for cutting and welding, metals, glass, and thermoplastics. Most water torches combine or create the oxyhydrogen directly after electrolysis for fuel of the torch and pump the oxyhydrogen to the torch tip for burning. Due to the explosiveness of oxyhydrogen, and the development of safer alternative torches, the water torch is seldom used today, but it remains the preferred cutting tool in some niche applications, like oxy-fuel welding and cutting.

As such, there is clearly a need to provide a water torch that is safer to use. In addition, as one skilled in the art readily understands, more efficient water torches with higher temperature flames are always more desirable in torches.

The instant disclosure of a water torch with a tip for providing separate streams of hydrogen and oxygen at its exit is designed to address at least some aspects of the problems discussed above.

### SUMMARY

Briefly described, in a possibly preferred embodiment, the present disclosure overcomes the above-mentioned disadvantages and meets the recognized need for such a device by providing a water torch tip for providing separate streams of hydrogen gas and oxygen gas at its exit, and a water torch with such a tip for providing separate streams of hydrogen gas and oxygen gas at its exit. The tip has a tip inlet end and a tip outlet end. The tip includes an inner housing and an outer housing. The inner housing has an inner housing inlet port at the tip inlet end in communication with an inner housing outlet opening at the tip outlet end via an inner tip passage. The outer housing surrounds the inner housing. The outer housing includes an outer housing inlet port at the tip inlet end in communication with an outer housing outlet opening at the tip outlet end via an outer tip passage created between the inner housing and the outer housing. The outer housing outlet opening and the inner housing outlet opening are at approximately the tip outlet end, where the outer housing outlet opening surrounding the inner housing outlet opening.

One feature of the instant disclosure may be where the outer housing outlet opening and the inner housing outlet opening may terminate at a same exit tip location at the inlet tip end. With this, the outer housing outlet opening is in line with the inner housing outlet opening.

Another feature of the instant disclosure may be the inclusion of a baffle section in or with the inlet tip end. The baffle section may include a center baffle hole and at least one outer baffle hole. The center baffle hole may create the inner housing inlet port in communication with the inner tip passage. The at least one outer baffle hole may create the outer housing inlet port in communication with the outer tip passage. In select embodiments, the at least one outer baffle hole may include eight outer baffle holes equally spaced approximate an outside baffle diameter of the baffle section.

Another feature of the instant disclosure may be that the inner housing can include a needle shaped distal end section terminating with the inner housing outlet opening. The needle shaped distal end section of the inner housing may have a gauge for controlling the flow out of the inner housing outlet opening. As examples, the gauge may be 16 gauge, 19 gauge, 21 gauge, or any other desired gauge for providing the desired flow through the inner housing outlet opening.

Another feature of the instant disclosure may be that the inner housing can include a tapered inner section, or a plurality of tapered inner sections. The tapered inner section(s) may narrow the inner housing from the tip inlet end to the tip outlet end.

Another feature of the instant disclosure may be that the outer housing may include a tapered outer section, or a plurality of tapered outer sections. The tapered outer section(s) may narrow the outer housing from the tip inlet end to the tip outlet end.

Another feature of the instant disclosure may be that the inner housing can include a threaded exterior portion approximate the tip inlet end, and the outer housing can include a corresponding threaded interior portion for attaching the outer housing to the inner housing.

In another aspect, the tip may be attached to a handle. The handle may be for providing a means for manually moving or manipulating the tip. In general, the handle may include a handle inlet end, and a handle outlet end attached to the tip. A first handle channel may connect a first inlet port to a first outlet port. A second handle channel may connect a second inlet port to a second outlet port. In select embodiments, the handle may include an outer diameter tube for the first handle channel and in inner tube for the second handle channel.

In another aspect, the tip for a torch may be used on a water torch. With the water torch, the oxygen and hydrogen are moved into the tip inlet end via the outer housing inlet port and the inner housing inlet port, or vice versa, whereby separate streams of hydrogen gas and oxygen gas are provided at the tip outlet end. In select embodiments, the oxygen may be moved into the tip inlet end via the outer housing inlet port and hydrogen may be moved into the tip inlet end via the inner housing inlet port, whereby the flow of the separate hydrogen and oxygen gas streams may be regulated by the tip.

In another aspect, a water torch is disclosed herein that includes the tip configured for providing separate streams of hydrogen gas and oxygen gas at its exit. The tip generally includes a tip inlet end and a tip outlet end. The tip includes an inner housing and an outer housing. The inner housing has an inner housing inlet port at the tip inlet end in communication with an inner housing outlet opening at the tip outlet end via an inner tip passage. The outer housing surrounds the inner housing. The outer housing includes an outer housing inlet port at the tip inlet end in communication with an outer housing outlet opening at the tip outlet end via an outer tip passage created between the inner housing and the outer housing. The outer housing outlet opening and the inner housing outlet opening are at approximately the tip outlet end, where the outer housing outlet opening surrounding the inner housing outlet opening. Wherein oxygen may be moved into the tip inlet end via the outer housing inlet port and hydrogen may be moved into the tip inlet end via the inner housing inlet port (or vice versa), whereby separate streams of the hydrogen gas and the oxygen gas are provided at the tip outlet end and the flow of hydrogen gas and oxygen gas may be regulated by the tip.

In select embodiments of the water torch disclosed herein, the outer housing outlet opening and the inner housing outlet opening may terminate at a same exit tip location at the inlet tip end, where the outer housing outlet opening is in line with the inner housing outlet opening.

One feature of the water torch disclosed herein is the inclusion of a handle for manual operation of the tip. The handle may generally include a handle inlet end and a handle outlet end attached to the tip. A first handle channel may connect a first inlet port to a first outlet port. A second handle channel may connect a second inlet port to a second outlet port.

Another feature of the water torch disclosed herein, may be the inclusion of an electrolysis cell. The electrolysis cell may be configured for creating a hydrogen gas and an oxygen gas from water via an electrical current. The electrolysis cell may be a proton exchange membrane cell that separates the hydrogen from the oxygen in water via an electrical current. The electrolysis cell may have a water inlet. In select embodiments, the water inlet may be on a front circular face of the electrolysis cell approximate a bottom for introducing water into the electrolysis cell. The electrolysis cell may have a hydrogen outlet. In select embodiments, the hydrogen outlet may be on the front circular face of the electrolysis cell approximate a top for removing the hydrogen created from the electrolysis cell. The electrolysis cell may have an oxygen outlet. In select embodiments, the oxygen outlet may be on the front circular face of the electrolysis cell approximate the top for removing the oxygen created from the electrolysis cell. The electrolysis cell may have a cathode. In select embodiments, the cathode may be of a substantially circular shape with a protruding cathode tab for providing a negative current connection thereby creating a negative electrode in the electrolysis cell. The electrolysis cell may have an anode. In select embodiments, the anode may be of a substantially circular shape with a protruding anode tab for providing a positive current connection thereby creating a positive electrode in the electrolysis cell. The electrolysis cell may also have a plurality of insulated protrusions. In select embodiments, the plurality of insulating protrusions may protrude from the front circular face and a back circular face for insulating the electrolysis cell.

Another feature of the water torch disclosed herein is the inclusion of a housing. The housing may be for enclosing the electrolysis cell. In select embodiments, the housing may have a substantially square shape. This shape may include a housing top, front, and housing bottom. In select embodiments, the housing top may have a lift handle for carrying the electrolysis cell, and/or a water port for filling the electrolysis cell with water. The front may include a user interface. In select embodiments, the user interface may include a water level indicator configured for indicating an amount of water in the electrolysis cell with levels marked for full, and empty. In other select embodiments, the user interface may include a water temperature display configured for displaying a water temperature of the water in the electrolysis cell. In other select embodiments, the user interface may include a voltage display configured for displaying a voltage of the electrical current across the electrolysis cell. In other select embodiments, the user interface may include an amperage display configured for displaying a strength of the electrical current across the electrolysis cell. In other select embodiments, the user interface may include a power button configured for turning the electrolysis cell on and off. In other select embodiments, the user interface may include a cell pump indicator light configured to light up when a cell pump is operating. In other select embodiments, the user interface may include a filter pump indicator light configured to light up when a filter pump is operating. In other select embodiments, the user interface may include a fan motor indicator light configured to light up when a fan motor is operating. The front may also include a drain approximate the housing bottom configured for draining the water out of the electrolysis cell. In other select embodiments, the front may include a hydrogen connector in communication with the hydrogen outlet of the electrolysis cell, and an oxygen connector in communication with the oxygen outlet of the electrolysis cell. In other select embodiments, the housing may include a plurality of vents configured for venting the electrolysis cell inside the housing.

Another feature of the water torch disclosed herein is the inclusion of a hydrogen line and an oxygen line. The hydrogen line may be connected to the hydrogen outlet of the electrolysis cell at one end, and in communication with the inner housing inlet port in the tip via its other end (either directly or through the handle). The hydrogen line may thus be configured for moving the hydrogen gas created from the electrolysis cell into the inner tip passage of the tip. The oxygen line may be connected to the oxygen outlet of the electrolysis cell at one end, and in communication with the outer housing inlet port in the tip via its other end (either directly or through the handle). The oxygen line may thus be configured for moving the oxygen gas created from the electrolysis cell into the outer tip passage of the tip.

### BRIEF DESCRIPTION OF THE DRAWINGS

The present apparatuses, systems and methods will be better understood by reading the Detailed Description with reference to the accompanying drawings, which are not necessarily drawn to scale, and in which like reference numerals denote similar structure and refer to like elements throughout, and in which:

FIG. 1 is a side view of the tip for providing separate streams of hydrogen and oxygen at its exit according to select embodiments of the instant disclosure with the torch handle;

FIG. 2A is a side view of the top of the torch handle with the tip from FIG. 1 for providing separate streams of hydrogen and oxygen at its exit according to select embodiments of the instant disclosure;

FIG. 2B is a partially disassembled side view of the top of the torch handle with the tip for providing separate streams of hydrogen and oxygen at its exit from FIG. 2A showing the inner housing with the outer housing removed;

FIG. 3A is a side view of another embodiment of the tip for providing separate streams of hydrogen and oxygen at its exit according to select embodiments of the instant disclosure;

FIG. 3B is a partially disassembled side view of the tip for providing separate streams of hydrogen and oxygen at its exit from FIG. 3A showing the inner housing with the outer housing removed;

FIG. 4 is a perspective side view of another embodiment of the tip for providing separate streams of hydrogen and oxygen at its exit according to select embodiments of the instant disclosure of the inner housing;

FIG. 5 is a schematic assembly view of select embodiments of the handle for the water torch tip for providing separate streams of hydrogen and oxygen at its exit according to select embodiments of the instant disclosure;

FIG. 6 is a top and cross-sectional view of select embodiments of the handle inlet of the handle from FIG. 5 for the water torch tip for providing separate streams of hydrogen and oxygen at its exit according to select embodiments of the instant disclosure;

FIG. 7 is a top and cross-sectional view of select embodiments of the baffle portion of the tip for providing separate streams of hydrogen and oxygen at its exit from FIG. 5 according to select embodiments of the instant disclosure;

FIG. 8 is a schematic assembly view of select embodiments of the tip for providing separate streams of hydrogen and oxygen at its exit according to select embodiments of the instant disclosure;

FIG. 9 is a schematic assembly view of select embodiments of the tip for providing separate streams of hydrogen and oxygen at its exit according to select embodiments of the instant disclosure;

FIG. 10A is a perspective view of the water torch with the tip for providing separate streams of hydrogen and oxygen at its exit according to select embodiments of the instant disclosure with a handle having the second handle channel made from an outer diameter;

FIG. 10B is a perspective view of another embodiment of the water torch with the tip for providing separate streams of hydrogen and oxygen at its exit according to select embodiments of the instant disclosure with a handle made from the first handle channel and the second handle channel;

FIG. 11 is a perspective view of the electrolysis cell for the water torch according to select embodiments of the instant disclosure;

FIG. 12A is an environmental perspective view of the water torch handle with the tip for providing separate streams of hydrogen and oxygen at its exit according to select embodiments of the instant disclosure being held by a user at the joining of the tip and the handle while lit;

FIG. 12B is an environmental perspective view of the water torch handle with the tip for providing separate streams of hydrogen and oxygen at its exit according to select embodiments of the instant disclosure being held by a user at the tip and handle while lit; and

FIG. 12C is an environmental perspective view of the water torch handle with the tip for providing separate streams of hydrogen and oxygen at its exit according to select embodiments of the instant disclosure being held by a user at the tip outlet end while lit.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

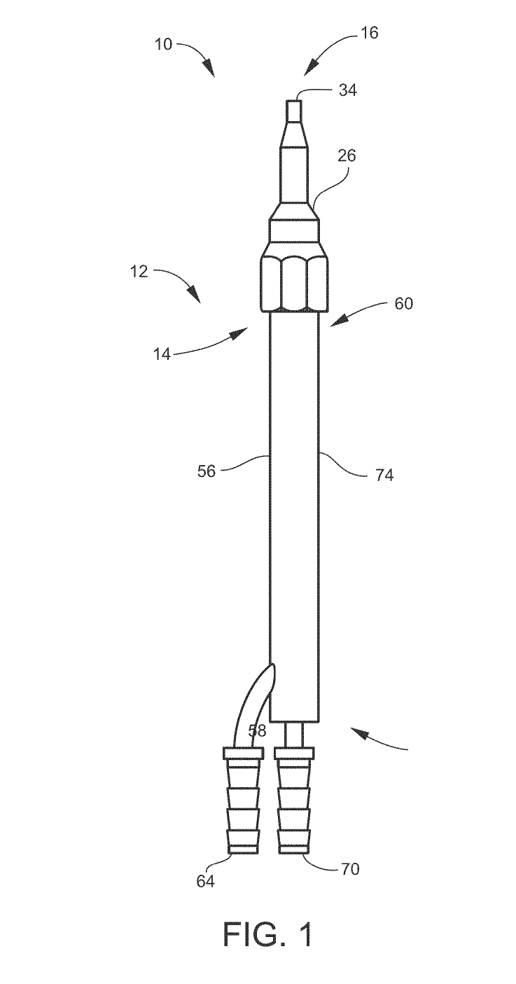

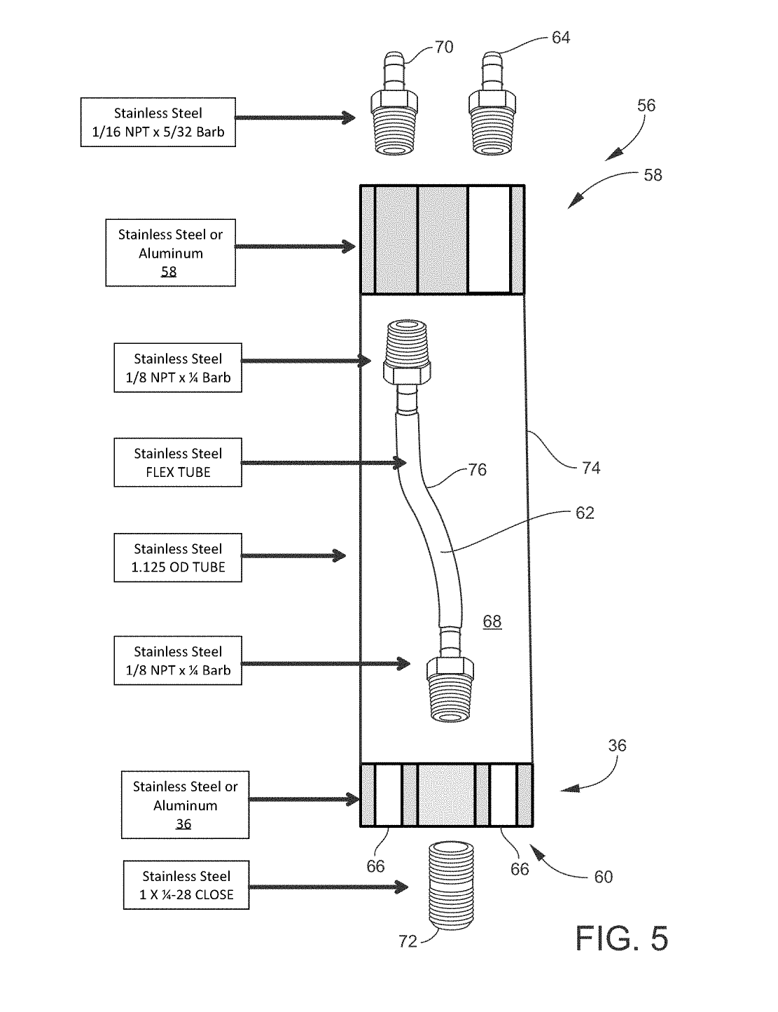

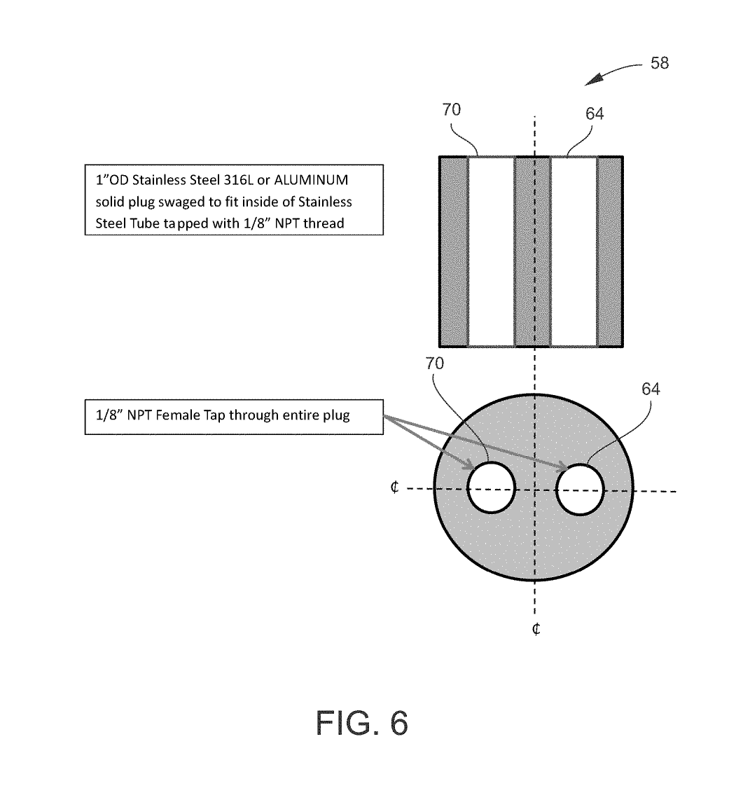

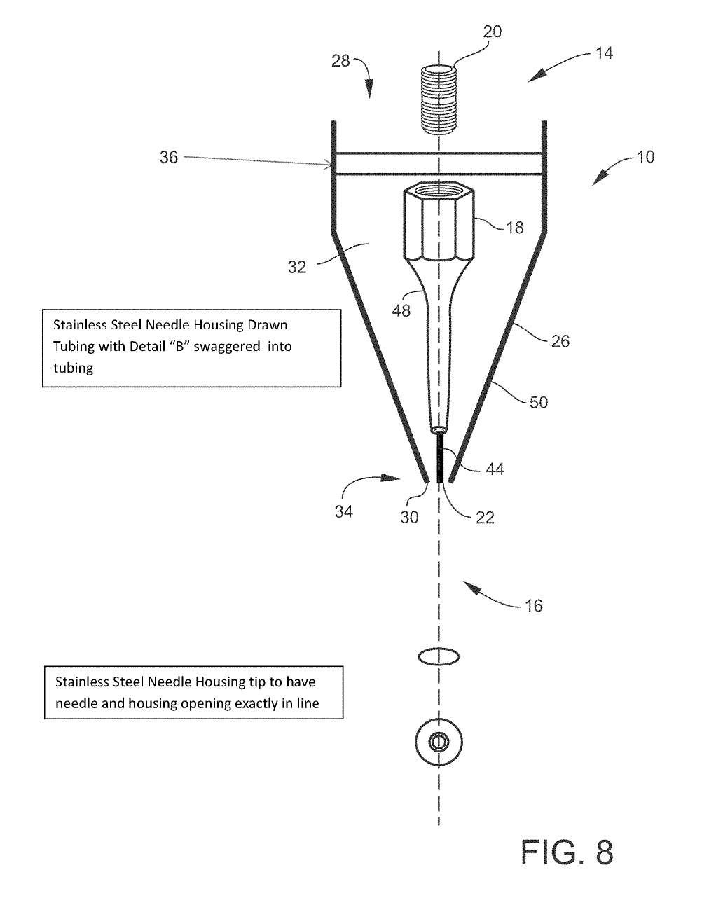

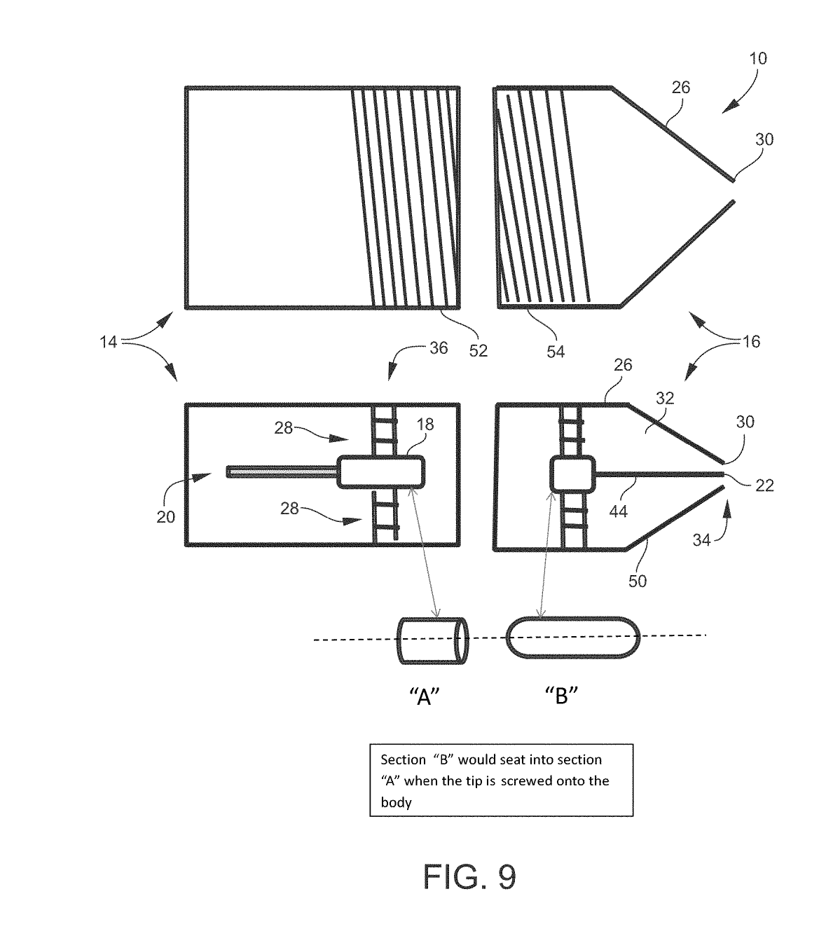

In describing the exemplary embodiments of the present disclosure, as illustrated in FIGS. 1-12C, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

Referring now to FIGS. 1-9 by way of example, and not limitation, therein is illustrated example embodiments of tip 10 for torch 10, like water torch 78. Tip 10 may be for providing separate streams of hydrogen gas and oxygen gas at its exit. Tip 10 may generally include tip inlet end 14 and tip outlet end 16. Inner housing 18 or inner shell type structure may be included in tip 10. Inner housing 18 may include inner housing inlet port 20 at tip inlet end 14 in communication with inner housing outlet opening 22 at tip outlet end 16 via inner tip passage 24. Inner tip passage 24 may be any size or shape passage, conduit, channel, tube, pipe, the like, etc. for moving fluid like gas from inner housing inlet port 20 to inner housing outlet opening 22. Outer housing 26 or outer shell type structure may also be included in tip 10. Outer housing 26 may surround inner housing 18. Outer housing 26 may include outer housing inlet port 28 at tip inlet end 14 that may be in communication with outer housing outlet opening 30 at tip outlet end 16 via outer tip passage 32. Outer tip passage 32 may include any size or shape passage, conduit, channel, pipe, tube, the like, etc. for moving fluid like gas from outer housing inlet port 28 to outer housing outlet opening 30. As shown in the figures, outer tip passage 32 may be created by the space between the outside wall of inner housing 18 and the inside wall of outer housing 26.

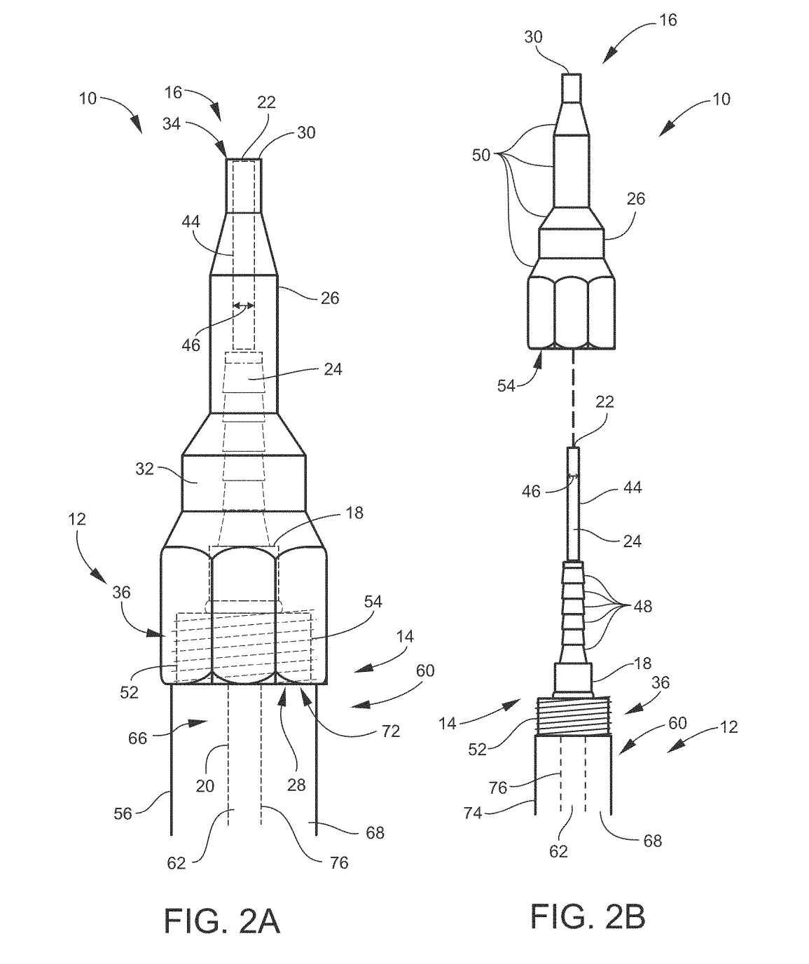

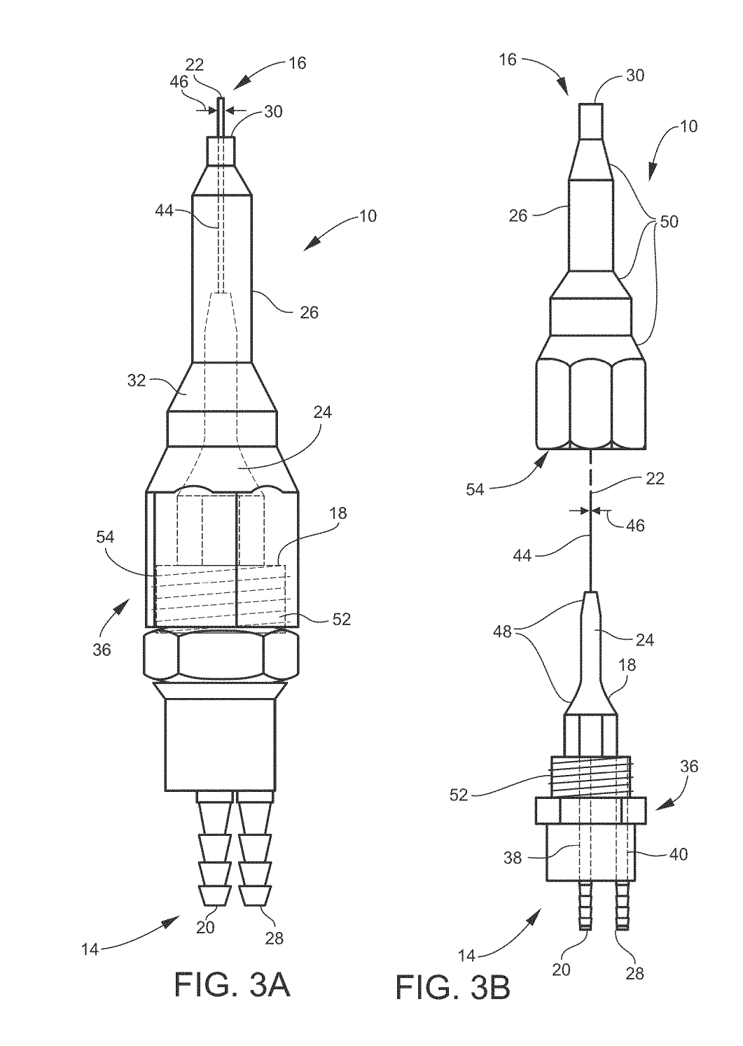

Outer housing outlet opening 30 and inner housing outlet opening 22 may be positioned at approximately the tip outlet end 16. As such, outer housing outlet opening 30 may surround inner housing outlet opening 22. In select embodiments, as shown in FIGS. 1-2, outer housing outlet opening 30 and inner housing outlet opening may terminate at same exit tip location 34 at tip inlet end 14. As such, in these embodiments outer housing outlet opening 30 may be in line with inner housing outlet opening 22 at same exit tip location 34. In other select embodiments, as shown in FIG. 3A, inner housing outlet opening 22 may extend slightly past outer housing outlet opening 30. In other select embodiments (not shown), inner housing outlet opening 22 may be recessed slightly inside outer housing outlet opening 30. These various embodiments may provide for various flows of gas out of tip outlet end 16 for various desired flames from torch 12. However, the embodiment shown in FIGS. 1-2 where outer housing outlet opening 30 and inner housing outlet opening may terminate at same exit tip location 34 at tip inlet end 14 may be preferred for torch 12 for the optimal creation of oxyhydrogen at the exit of tip 10.

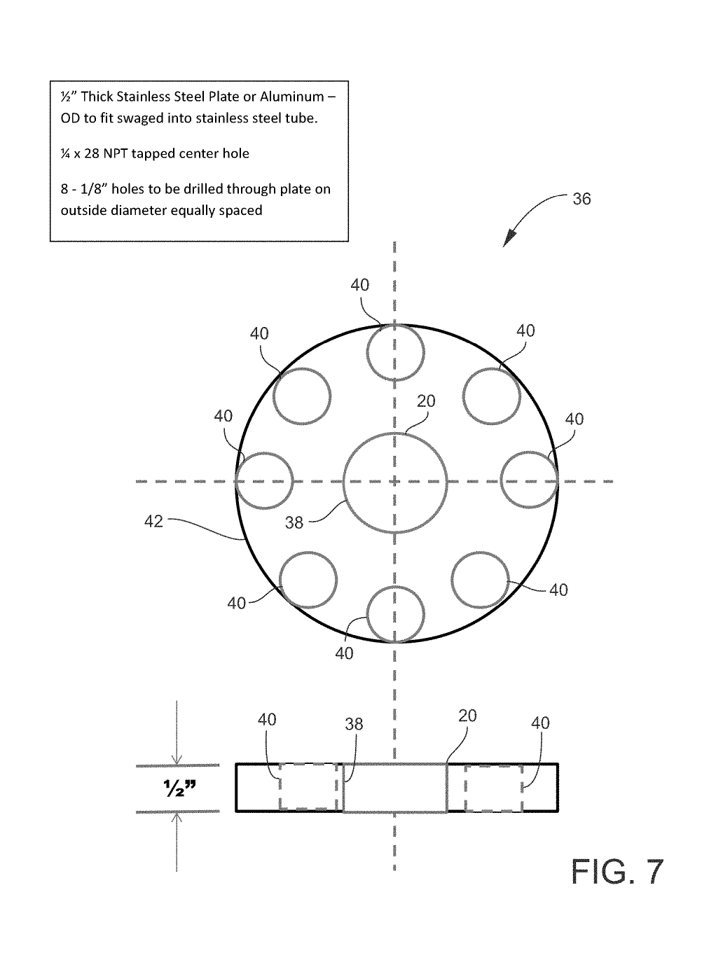

Baffle section 36 may be included in tip 10. See FIGS. 2-5 and 7-10. Baffle section 36 may be for providing the required inlets for separate gases into tip 10 via tip inlet end 14. Baffle section 36 may include center baffle hole 38 and at least one outer baffle hole 40. Center baffle hole 38 may be for creating inner housing inlet port 20 that is in communication with inner tip passage 24. The at least one outer baffle hole 40 may be for creating outer housing inlet port 28 that is in communication with outer tip passage 32. In select embodiments, as shown in FIG. 3B, the at least one outer baffle hole 40 may include a single outer baffle hole 40. In other select possibly preferred embodiments, as shown in FIGS. 2, 4, 5 and 7, the at least one outer baffle hole 40 may include a plurality of outer baffle holes, including, but not limited to, eight outer holes equally spaced approximate outside baffle diameter 42 of baffle section 36. Referring to FIG. 7, in select embodiments, center baffle hole 38 may be a ¼×28 NPT tapped center hole (for connecting inner housing inlet port 20), and each of the at least one outer baffle holes 40 may be ⅛-inch hole drilled through the baffle section 36 approximate outside baffle diameter 42.

Needle shaped distal end 44 may be included with inner housing 18 of tip 10. See FIGS. 2A, 2B, 3A, 3B, 4, 8 and 9. Needle shaped distal end 44 may be for regulating the flow of fluid like gas out of inner housing outlet opening 22 at tip outlet end 16. Needle shaped distal end 44 may terminate with inner housing outlet opening 22. Needle shaped distal end 44 may include gauge 46 or thickness for regulating the flow out of inner housing outlet opening 22. Gauge 46 of needle shaped distal end 44 may be any desired gauge of needle shaped distal end 44 for providing any desired flow out of inner housing outlet opening 22. As examples, and clearly not limited thereto, gauge 46 may be 16 gauge, 19 gauge, 21 gauge, or other like or similar gauges. In addition to gauge 46, tip 10 may also regulate and control the flow out of outer housing outlet opening 30 by controlling the size or opening between outer housing outlet opening 30 and needle shaped distal end 44.

Tapered inner section 48, or a plurality of tapered inner sections 48 may be included in inner housing 18 of tip 10. See FIGS. 2B, 3B, 4 and 8. Tapered inner section 48 or plurality of tapered inner sections 48 may be for shaping inner housing 18 from tip inlet end 14 toward tip outlet end 16 and needle shaped distal end 44. As such, inner housing 18 may taper narrower from tip inlet end 14 to tip outlet end 16 via tapered inner section 48 or plurality of tapered inner section 48.

Tapered outer section 50, or a plurality of tapered outer sections 50 may be included in outer housing 26 of tip 10. See FIGS. 2B, 3B, 8 and 9. Tapered outer section 50 or plurality of tapered outer sections 50 may be for shaping outer housing 26 from tip inlet end 14 toward tip outlet end 16. As such, outer housing 26 may taper narrower from tip inlet end 14 to tip outlet end 16 via tapered outer section 50 or plurality of tapered outer sections 50. Tapered outer section 50, or plurality of tapered outer sections 50 may generally taper outer housing 26 to conform to the shape of inner housing 18 while leaving enough space for outer tip passage 32 in tip 10.

Threaded exterior portion 52 may be included with inner housing 18, and corresponding threaded interior portion 54 may be included with outer housing 26. See FIGS. 2A, 2B, 3A, 3B, and 9. Threaded exterior portion 52 of inner housing 18 may be approximate tip inlet end 14, and the corresponding threaded interior portion 54 may also be approximate tip inlet end 14. The threaded exterior portion 52 of inner housing 18 may allow outer housing 26 to connect to inner housing 18 via the corresponding threaded interior portion 54 approximate tip inlet end 14. This threaded connection may seal outer housing 26 to inner housing 18 for creating outer tip passage 32 between outer housing 26 and inner housing 18.

Referring now specifically to the embodiment of tip 10 shown in FIGS. 1, 2A and 2B, an example tip was created as shown. Outer housing 26 was machined from brass to form the outer shape of the torch tip 10. At the tip inlet end 14, the interior was threaded to create threaded interior portion 54 of outer housing 26. The outer housing outlet opening 30 was filled with silver solder and drilled to a diameter twice that of the gauge 46 of needle shaped distal end 44. The inner housing 18 was machined from a round brass plug. Prior to the inner housing 18 being machined to its final shape two procedures were done. First, outer baffle holes 40 were drilled approximate outside baffle diameter 42 in a circular pattern through the circular plug, which served as outer housing inlet ports 28 for communication with outer tip passage 32 for oxygen. Then, the same plug was tapped in the center with a ¼-20 thread to create the inner housing inlet port 20. This thread will accept needle shaped distal end 44. This portion will serve as inner tip passage 24 for hydrogen. Finally, the plug was threaded on the exterior with a ⅜-16 thread to create threaded exterior portion 52. Outer housing 26 and inner housing 18 were then screwed together and silver soldered to become the entire assembly of tip 10.

Referring now specifically to the embodiments of tip 10 for providing separate streams of hydrogen and oxygen at its exit in FIGS. 3A and 3B, another shape of tip 10 is shown. This shape of outer housing 26 and inner housing 18 clearly differs in profile from the embodiment shown in FIGS. 2A and 2B. In addition, tip inlet end 14 is shown with protruding inner housing inlet port 20 and outer housing inlet port 28. Further, outer tip passage 32 is just created by one outer baffle hole 40 in baffle section 36 for a single outer housing inlet port 28. Finally, needle shaped distal end 44 is clearly a different shaped and sized needle with a smaller gauge 46.

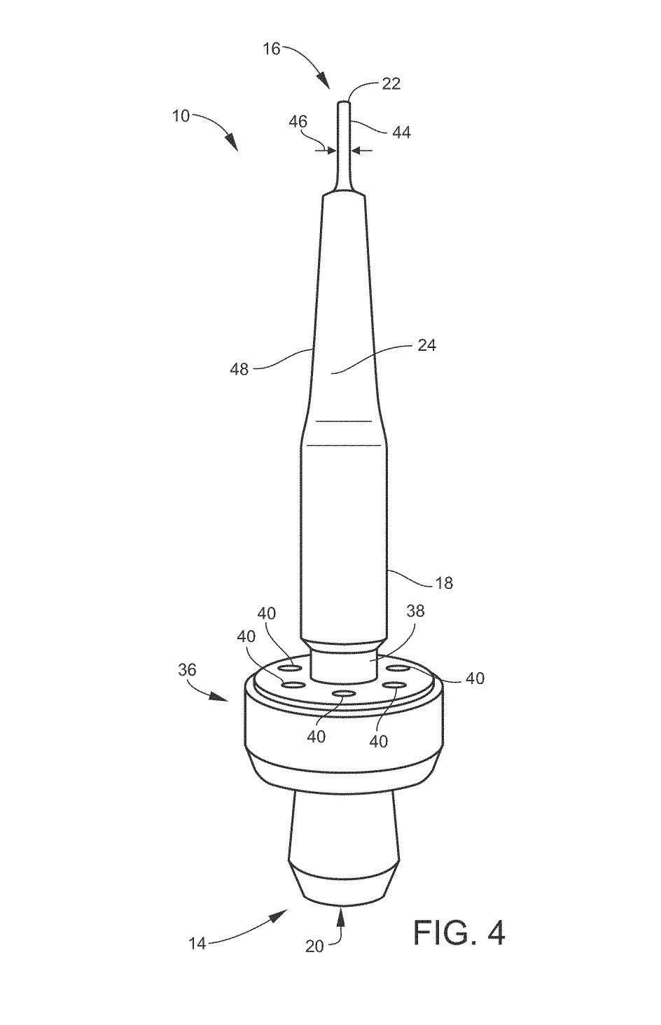

Referring now specifically to the embodiments of tip 10 for providing separate streams of hydrogen and oxygen at its exit in FIG. 4, yet another shape of tip 10 is shown. This figure merely shows inner housing 18 which clearly differs in profile and shape from the embodiment shown in FIGS. 2 and 3. Outer tip passage 32 is created by eight outer baffle holes 40 in baffle section 36 for eight outer housing inlet ports 28. Finally, needle shaped distal end 44 is clearly a different shaped and sized needle with a different gauge 46.

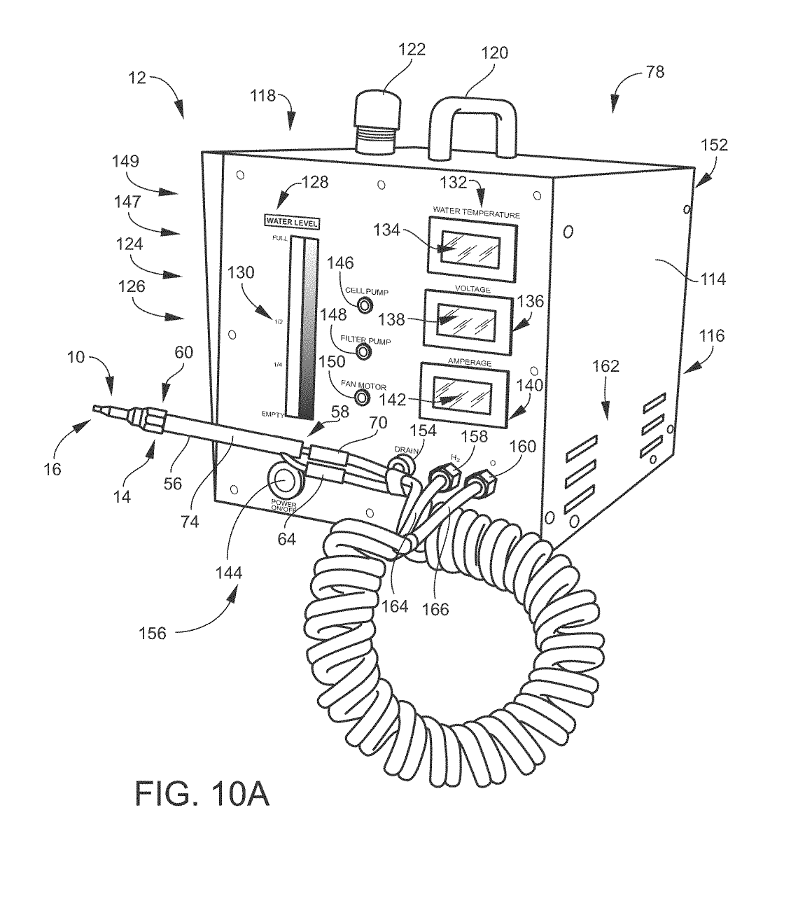

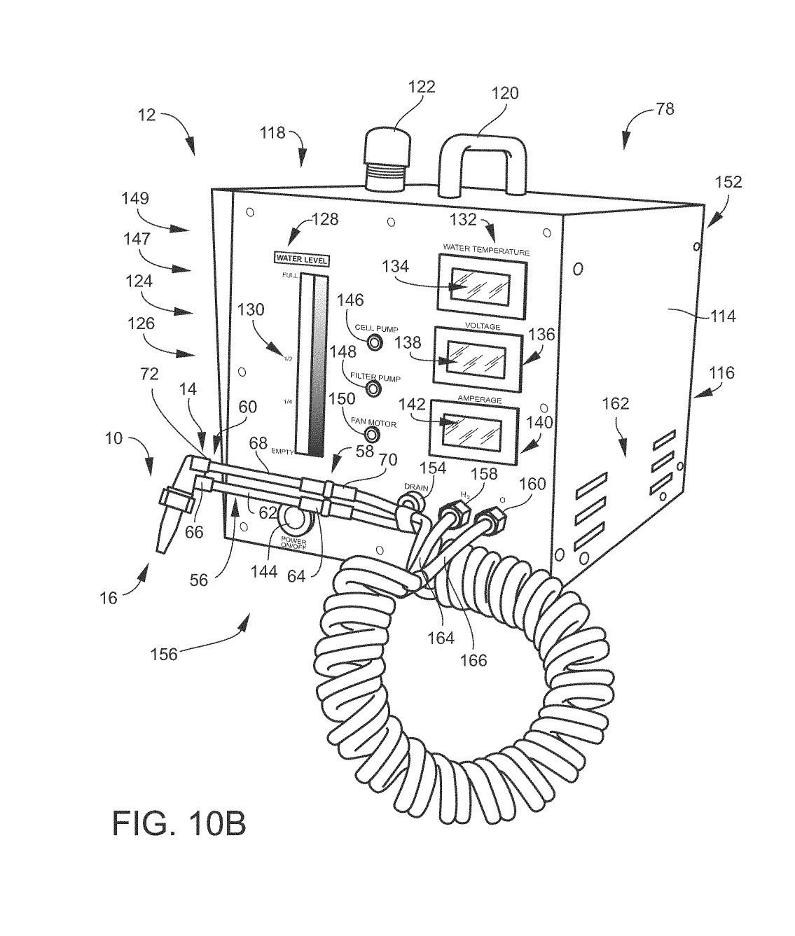

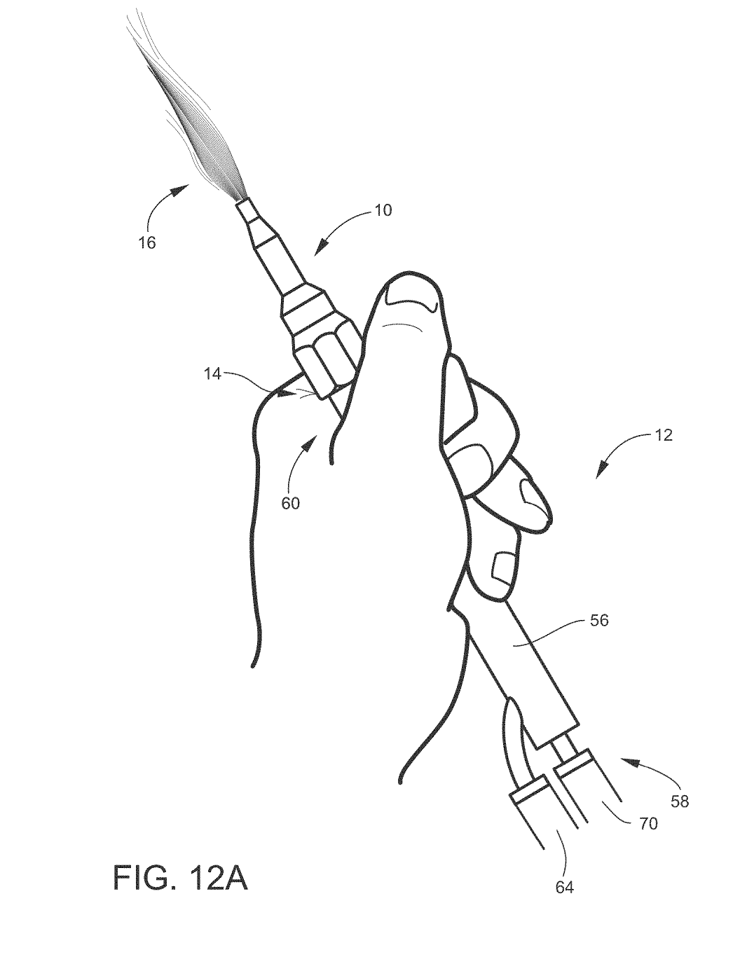

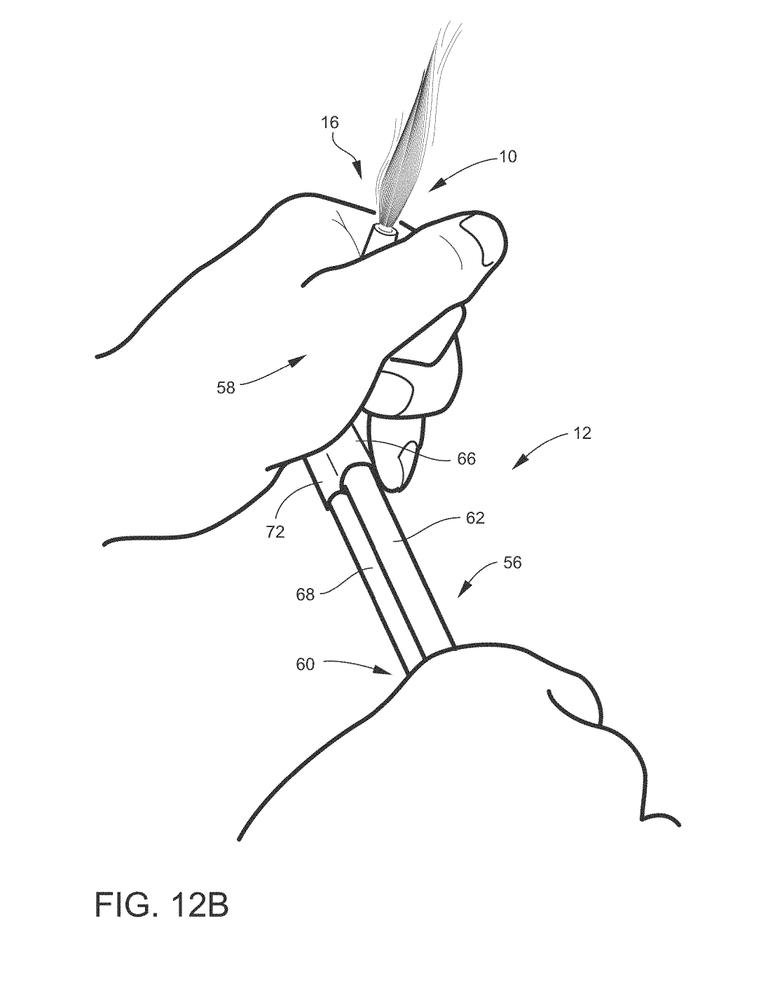

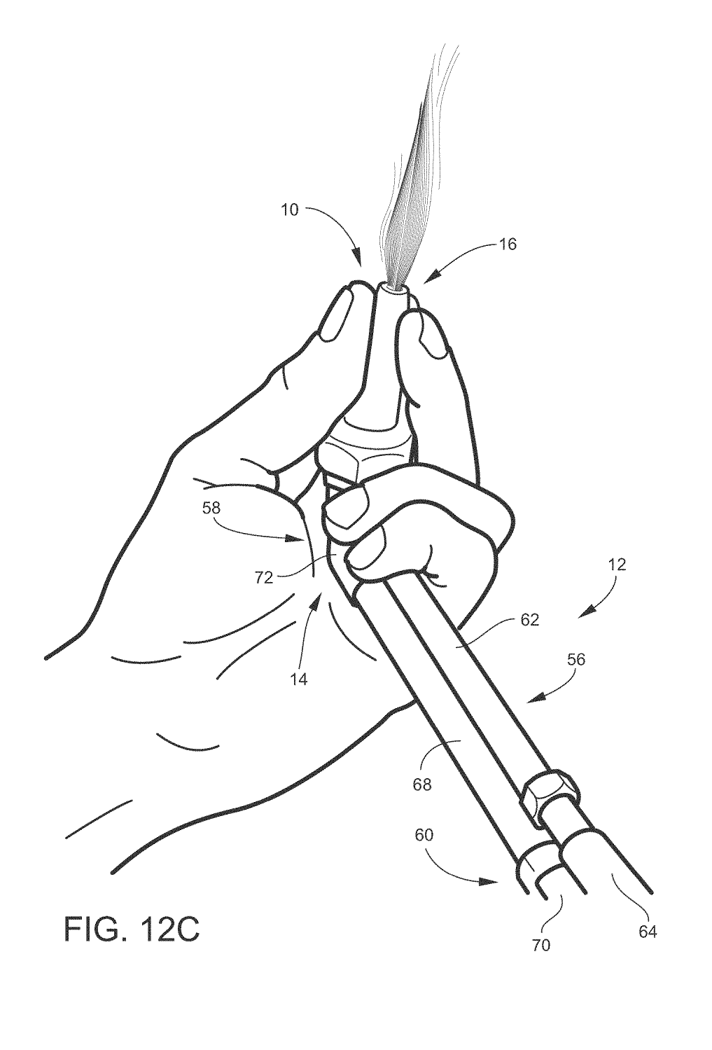

Handle 56 may be included with tip 10. See FIGS. 1, 2A, 2B, 5, 10A, 10B, 12A, 12B, and 12C. Handle 56 may be attached to tip 10 for manual manipulation of tip 10, like as shown in FIG. 12. Handle 56 may generally include handle inlet end 58 and handle outlet end 60. Tip 10 may be connected to attached to handle 56 at handle outlet end 60. First handle channel 62 may connect first inlet port 64 to first outlet port 66 of handle 56. First handle channel 62 may be for moving a first fluid, like a first gas (i.e. hydrogen or oxygen) through handle 56 to tip 10. First handle channel 62 may be any size or shape channel, conduit, passage, pipe, tube, the like etc. for moving a fluid through handle 56 to tip 10. Second handle channel 68 may connect second inlet port 70 to second outlet port 72 of handle 56. Second handle channel 68 may be for moving a second fluid, like a second gas (i.e. hydrogen or oxygen) through handle 56 to tip 10. Second handle channel 68 may be any size or shape channel, conduit, passage, pipe, tube, the like etc. for moving a fluid through handle 56 to tip 10. Referring to FIGS. 1, 2A, 2B, 5, 10A, and 12A, handle 56 may include outer diameter tube 74 and inner tube 76. Outer diameter tube 74 may be for first handle channel 62 and inner tube 76 may be for second handle channel 68, or vice versa. As such, outer diameter tube 74 may provide an outer surface made for gripping handle 56. In other select embodiments, as shown in FIGS. 10B, 12B and 12C, handle 56 may be made from separate or adjacent tubes or pipes for first handle channel 62 and second handle channel 68.

Tip 10 may used on torch 12, like water torch 78. See FIGS. 10A, 10B, 11, 12A, 12B, and 12C. Water torch 78 may include any of the various embodiments of tip 10 as shown and or described herein, including, but not limited to, any of the various shapes and sizes of tip 10, and any of the embodiments of handle 56. With water torch 78, oxygen and hydrogen may be moved into tip inlet end 14 via outer housing inlet port 28 and inner housing inlet port 20, or vice versa, whereby separate streams of hydrogen gas and oxygen gas may be created at tip outlet end 16. More specifically, as shown in the Figures, oxygen may be moved into tip inlet end 14 via outer housing inlet port 28 and into outer tip passage 32, and hydrogen may be moved into tip inlet end 14 via inner housing inlet port 20 and into inner tip passage 24. As such, separate streams of hydrogen and oxygen may be provided at tip outlet end 16 with hydrogen flowing out of inner housing outlet opening 22 via needle shaped distal end 44 and oxygen flowing out of outer housing outlet opening 30 at same exit tip location 34, and the ratio and/or flow of hydrogen and oxygen may regulated by tip 10.

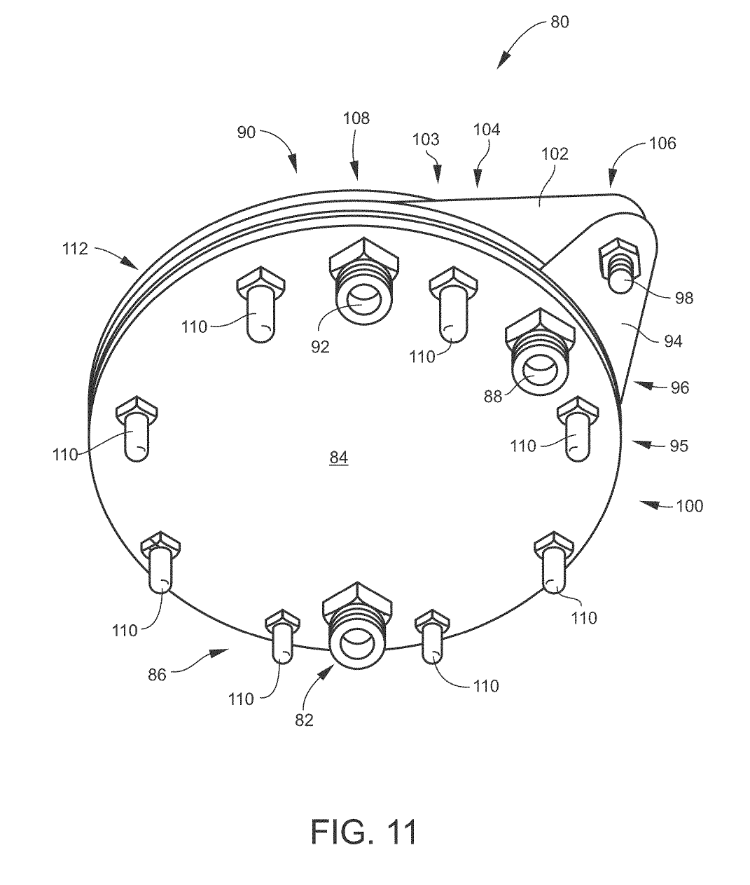

Referring now to FIG. 11, electrolysis cell 80 may be included in water torch 78. Electrolysis cell 80 may be for creating a hydrogen gas and an oxygen gas from water via an electrical current. Electrolysis cell 80 may be any known electrolysis cell or any device capable of creating oxygen and hydrogen from water. In select embodiments, electrolysis cell 80 may be a proton exchange membrane cell that separates the hydrogen from the oxygen in water via an electrical current. Electrolysis cell 80 may generally include a circular shape with circular shaped anodes and cathodes. Electrolysis cell 80 may generally include water inlet 82, hydrogen outlet 88, oxygen outlet 92, cathode 94 and anode 102. Water inlet 82 may be for introducing water into electrolysis cell 80. Water inlet 82 may be any port, opening, channel, the like, etc. for introducing water into electrolysis cell 80. In select embodiments, as shown in FIG. 11, water inlet 82 may be on front circular face 84 of the electrolysis cell 80 approximate bottom 86. Hydrogen outlet 88 may be for removing hydrogen created in electrolysis cell 80. Hydrogen outlet 88 may be any port, opening, channel, the like, etc. for removing hydrogen from electrolysis cell 80. In select embodiments, hydrogen outlet 88 may be on front circular face 84 of electrolysis cell 80 approximate top 90. Oxygen outlet 92 may be for removing oxygen created in electrolysis cell 80. Oxygen outlet 92 may be any port, opening, channel, the like, etc. for removing oxygen from electrolysis cell 80. In select embodiments, oxygen outlet 92 may be on front circular face 84 of electrolysis cell 80 approximate top 90 for removing the oxygen created from electrolysis cell 80. Cathode 94 may be for providing a negative charge into electrolysis cell 80. In select embodiments, cathode 94 may be of substantially circular shape 95 with protruding cathode tab 96 for providing negative current connection 98 thereby creating negative electrode 100 in electrolysis cell 80. Anode 102 may be for providing a positive charge into electrolysis cell 80. In select embodiments, anode 102 may be of a substantially circular shape 103 with protruding anode tab 104 for providing positive current connection 106 thereby creating positive electrode 108 in electrolysis cell 80. The electrolysis cell 80 may also have a plurality of insulated protrusions 110, as shown in FIG. 11. The plurality of insulating protrusions may be for insulating the electrolysis cell from housing 114 and/or any other structures provided around electrolysis cell 80. In select embodiments, the plurality of insulating protrusions 110 may protrude from the front circular face 84 and the back circular face 112 of electrolysis cell 80 for insulating the electrolysis cell 80.

Referring now to FIGS. 10A and 10B, housing 114 may be included with water torch 78 with tip 10 for providing separate streams of hydrogen and oxygen at its exit. Housing 114 may be for enclosing the electrolysis cell 80. Housing 114 may have any desired size and/or shape. In select embodiments, the housing may have substantially square shape 116. This shape may include housing top 118, front 124, and housing bottom 156. In select embodiments, the housing top 118 may have lift handle 120 for carrying the electrolysis cell 80, and/or water port 122 for filling the electrolysis cell 80 with water.

User interface 126 may be included on the front 124 of housing 114. See FIGS. 10A and 10B. User interface 126 may be for providing an interface for a user to operate electrolysis cell 80 and water torch 78. User interface 126 may include any desired buttons, displays, operations, levers, switches, the like, etc. for operating electrolysis cell 80 and water torch 78. In select embodiments, user interface 126 may include water level indicator 128 configured for indicating amount of water in the electrolysis cell, including, but not limited to, as shown with levels 130 marked for full, and empty. In other select embodiments, user interface 126 may include water temperature display 132 configured for displaying water temperature 134 of the water in the electrolysis cell 80. In other select embodiments, user interface 126 may include voltage display 136 configured for displaying voltage 138 of the electrical current across the electrolysis cell 80. In other select embodiments, user interface 126 may include amperage display 140 configured for displaying strength 142 of the electrical current across electrolysis cell 80. In other select embodiments, user interface 126 may include power button 144 configured for turning electrolysis cell 80 on and off, including but not limited to, the electrical current, any pumps, fans, etc., like fan motor 152, cell pump 147 and/or filter pump 149. In other select embodiments, user interface 126 may include cell pump indicator light 146 configured to light up when cell pump 147 is operating. Cell pump 147 may be configured to automatically turn on and off when the power is on for electrolysis cell 80 and water torch 78 is operating. In other select embodiments, user interface 126 may include filter pump indicator light 148 configured to light up when filter pump 149 is operating. Filter pump 149 may be configured to automatically turn on and off when the power is on for electrolysis cell 80 and water torch 78 is operating for filtering the water in electrolysis cell 80. In other select embodiments, user interface 126 may include fan motor indicator light 150 configured to light up when fan motor 152 is operating. Fan motor 152 may be configured to automatically turn on and off when the power is on for electrolysis cell 80 and water torch 78 is operating for cooling off the electrolysis cell and components inside housing 114.

Front 124 of housing 114 may also include drain 154. Drain 154 may be for draining the water out of electrolysis cell 80 and housing 114. Drain 154 may be any device, opening, port, the like, etc. for draining water out of electrolysis cell 80 and housing 114. In select embodiments, drain 154 may be positioned approximate housing bottom 156 configured for draining the water out of electrolysis cell 80.

Vents 162 may also be included on housing 114. Vents 162 may be for venting the inside of housing 114 including electrolysis cell 80. Vents 162 may be anywhere in housing 114 and may be any shape or size.

Hydrogen connector 158 and oxygen connector 160 may also be included on housing 114. Hydrogen connector 158 and oxygen connector 160 may be for providing a connection between the hydrogen and oxygen produced from electrolysis cell 80 out of housing 114. Hydrogen connector 158 and oxygen connector 160 may be positioned anywhere on housing 114. In select embodiments, hydrogen connector 158 and oxygen connector 160 may be positioned on front 124 of housing 114. Hydrogen connector 158 may be in communication with hydrogen outlet 88 of electrolysis cell 80, and oxygen connector 160 may be in communication with oxygen outlet 92 of electrolysis cell 80.

Hydrogen line 164 and oxygen line 166 may be included with water torch 78. See FIGS. 10A and 10B. Hydrogen line 164 may be connected to hydrogen outlet 88 of the electrolysis cell at one end (via hydrogen connector 158), and in communication with inner housing inlet port 20 in tip 10 via its other end (either directly or through handle 56 through first handle channel 62 or second handle channel 68). Hydrogen line 164 may thus be configured for moving the hydrogen gas created from electrolysis cell 80 into inner tip passage 24 of tip 10 (or outer tip passage 32). Oxygen line 166 may be connected to oxygen outlet 92 of the electrolysis cell 80 at one end, and in communication with outer housing inlet port 28 in tip 10 via its other end (either directly or through handle 56 through first handle channel 62 or second handle channel 68). Oxygen line 166 may thus be configured for moving the oxygen gas created from electrolysis cell 80 into outer tip passage 32 of tip 10 (or inner tip passage 24).

In operation, referring now to FIGS. 12A, 12B, 12C, the water torch 78 is shown with tip 10 attached to handle 56. A flame is shown that is created by igniting the separate streams of hydrogen gas and oxygen gas provided at tip outlet end 16 of tip 10. As the separate streams of hydrogen gas and oxygen gas are provided at tip outlet end 16 of tip 10, or its exit, the torch is very efficient and safe as no heat is lost in the tip or handle. As such, a user can grip the tip and/or handle at any location. Specifically, FIG. 12A shows water torch 78 held by a user at the joining of tip 10 and handle 56 while lit. FIG. 12B shows water torch 78 being held by a user at tip 10 and handle 56 while lit. Finally, FIG. 12C shows water torch 78 held by a user at tip outlet end 16 while lit.

As such, the instant disclosure of tip 10 for providing separate streams of hydrogen and oxygen at its exit, and water torch 78 with tip 10, provides a safe and efficient water torch. Water torch 78 may provide a cool or cold handle and tip for manual operation and safety, while providing a flame with temperatures of 5,720 to 5,740 centigrade.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation.

Accordingly, the present disclosure is not limited to the specific embodiments illustrated herein, but is limited only by the following claims.

What is claimed is:

1. A tip for a torch comprising:
a tip inlet end;
a tip outlet end;
an inner housing with an inner housing inlet port at the tip inlet end in communication with an inner housing outlet opening at the tip outlet end via an inner tip passage;
an outer housing surrounding the inner housing, said outer housing including an outer housing inlet port at the tip inlet end in communication with an outer housing outlet opening at the tip outlet end via an outer tip passage created between the inner housing and the outer housing;
said outer housing outlet opening and said inner housing outlet opening being at approximately the tip outlet end, where said outer housing outlet opening surrounding said inner housing outlet opening.

2. The tip for a torch of claim 1, wherein the outer housing outlet opening and the inner housing outlet opening terminating at a same exit tip location at the inlet tip end, where the outer housing outlet opening is in line with the inner housing outlet opening.

3. The tip for a torch of claim 1, wherein the inlet tip end including a baffle section, said baffle section including:
a center baffle hole creating the inner housing inlet port in communication with the inner tip passage; and
at least one outer baffle hole creating the outer housing inlet port in communication with the outer tip passage.

4. The tip for a torch of claim 3, wherein the at least one outer baffle hole including eight outer holes equally spaced approximate an outside baffle diameter of the baffle section.

5. The tip for a torch of claim 3, wherein:
the center baffle hole is a ¼×28 NPT tapped center hole; and
each of the at least one outer baffle holes is a ⅛ inch hole drilled through the baffle section approximate the outside baffle diameter.

6. The tip for a torch of claim 1, wherein the inner housing including a needle shaped distal end section terminating with said inner housing outlet opening.

7. The tip for a torch of claim 6, wherein the needle shaped distal end section having a gauge for controlling flow out of the inner housing outlet opening, said gauge being selected from the group consisting of: 16 gauge; 19 gauge; and 21 gauge.

8. The tip for a torch of claim 6, wherein the inner housing including at least one tapered inner section, whereby the inner housing tapers narrower from the tip inlet end to the tip outlet end via the at least one tapered inner section.

9. The tip for a torch of claim 6, wherein the outer housing including at least one tapered outer section, whereby the outer housing tapers narrower from the tip inlet end to the tip outlet end via the at least one tapered outer section.

10. The tip for a torch of claim 1, wherein the inner housing including a threaded exterior portion approximate the tip inlet end, and the outer housing including a corresponding threaded interior portion.

11. The tip for a torch of claim 1, wherein the tip is attached to a handle, wherein the handle include:
a handle inlet end;
a handle outlet end attached to the tip;
a first handle channel connecting a first inlet port to a first outlet port; and
a second handle channel connecting a second inlet port to a second outlet port.

12. The tip for a torch of claim 11, wherein the handle including an outer diameter tube for the first handle channel and in inner tube for the second handle channel.

13. The tip for a torch of claim 1 being used on a water torch, wherein oxygen and hydrogen are moved into the tip inlet end via the outer housing inlet port and the inner housing inlet port, or vice versa, whereby separate streams of oxygen and hydrogen are provided at the tip outlet end.

14. The tip for a torch of claim 13, wherein oxygen is moved into the tip inlet end via the outer housing inlet port and hydrogen is moved into the tip inlet end via the inner housing inlet port, whereby separate streams of hydrogen and oxygen are provided at the tip outlet end and the flow of hydrogen and oxygen is regulated by the tip.

15. A water torch comprising:
a tip configured for providing separate streams of oxygen and hydrogen at its exit, said tip comprising:
a tip inlet end;
a tip outlet end;
an inner housing with an inner housing inlet port at the tip inlet end in communication with an inner housing outlet opening at the tip outlet end via an inner tip passage;
an outer housing surrounding the inner housing, said outer housing including an outer housing inlet port at the tip inlet end in communication with an outer housing outlet opening at the tip outlet end via an outer tip passage created between the inner housing and the outer housing;
said outer housing outlet opening and said inner housing outlet opening being at approximately the tip outlet end, where said outer housing outlet opening surrounding said inner housing outlet opening;
wherein oxygen is moved into the tip inlet end via the outer housing inlet port and hydrogen is moved into the tip inlet end via the inner housing inlet port, whereby separate streams of hydrogen and oxygen are provided at the tip outlet end and the flow of hydrogen and oxygen is regulated by the tip.

16. The water torch of claim 15, wherein the outer housing outlet opening and the inner housing outlet opening terminating at a same exit tip location at the inlet tip end, where the outer housing outlet opening is in line with the inner housing outlet opening.

17. The water torch according to claim 15 further comprising
a handle for manual operation of the tip, said handle including
a handle inlet end;
a handle outlet end attached to the tip;
a first handle channel connecting a first inlet port to a first outlet port; and
a second handle channel connecting a second inlet port to a second outlet port.

18. The water torch of claim 15 further comprising:
an electrolysis cell configured for creating a hydrogen gas and an oxygen gas from water via an electrical current, said electrolysis cell being a proton exchange membrane cell having:
a water inlet on a front circular face of the electrolysis cell approximate a bottom for introducing water into the electrolysis cell;
a hydrogen outlet on the front circular face of the electrolysis cell approximate a top for removing the hydrogen created from the electrolysis cell;
an oxygen outlet on the front circular face of the electrolysis cell approximate the top for removing the oxygen created from the electrolysis cell;
a cathode of a substantially circular shape with a protruding cathode tab for providing a negative current connection thereby creating a negative electrode in the electrolysis cell;
an anode of a substantially circular shape with a protruding anode tab for providing a positive current connection thereby creating a positive electrode in the electrolysis cell; and
a plurality of insulated protrusions protruding from the front circular face and a back circular face for insulating the electrolysis cell.

19. The water torch according to claim 18 further comprising:
a housing for enclosing the electrolysis cell, the housing having a substantially square shape including:
a housing top with a lift handle for carrying the electrolysis cell, and a water port for filling the electrolysis cell with water;
a front with a user interface including:
a water level indicator configured for indicating an amount of water in the electrolysis cell with levels marked for full, and empty;
a water temperature display configured for displaying a water temperature of the water in the electrolysis cell;
a voltage display configured for displaying a voltage of the electrical current across the electrolysis cell;
an amperage display configured for displaying a strength of the electrical current across the electrolysis cell;
a power button configured for turning the electrolysis cell on and off;
a cell pump indicator light configured to light up when a cell pump is operating;
a filter pump indicator light configured to light up when a filter pump is operating; and
a fan motor indicator light configured to light up when a fan motor is operating;
a drain approximate a housing bottom configured for draining the water out of the electrolysis cell;
a hydrogen connector in communication with the hydrogen outlet of the electrolysis cell;
an oxygen connector in communication with the oxygen outlet of the electrolysis cell; and
a plurality of vents configured for venting the electrolysis cell inside the housing.

20. The water torch according to claim 18 further comprising:
a hydrogen line connected to the hydrogen outlet of the electrolysis cell at one end, and in communication with the inner housing inlet port in the tip via its other end, said hydrogen line being configured for moving the hydrogen gas created from the electrolysis cell into the inner tip passage of the tip; and
an oxygen line connected to the oxygen outlet of the electrolysis cell at one end, and in communication with the outer housing inlet port in the tip via its other end, said oxygen line being configured for moving the oxygen gas created from the electrolysis cell into the outer tip passage of the tip.
